(19) United States
(12) Patent Application Publication
(10) Pub. No.: US 2015/0160860 A1
(43) Pub. Date: Jun. 11, 2015

(54) MEMORY MANAGEMENT USING ENLARGED ADDRESS SPACE

(71) Applicant: SAMSUNG ELECTRONICS CO., LTD., Suwon-si (KR)

(72) Inventor: MOON-SANG KWON, SEOUL (KR)

(21) Appl. No.: 14/554,121

(22) Filed: Nov. 26, 2014

(30) Foreign Application Priority Data
Dec. 5, 2013 (KR) 10-2013-0150757

(51) Int. Cl. G06F 3/06

(52) U.S. Cl. CPC G06F 3/061; G06F 3/0644; G06F 3/068

(57) ABSTRACT

A storage device comprises a storage unit having a first size, and a storage controller configured to control data transfer between the storage unit and a host in response to a request from the host, and further configured to convey size information of the storage unit to the host such that the host perceives the storage unit to have a second size different from the first size.

### CROSS-REFERENCE TO RELATED APPLICATION

This application claims priority under 35 USC 119 to Korean Patent Application No. 10-2013-0150757 filed on Dec. 5, 2013, the subject matter of which is hereby incorporated by reference.

### BACKGROUND OF THE INVENTION

The inventive concept relates generally to electronic data storage systems. More particularly, certain embodiments of the inventive concept relate to systems comprising a storage unit and a storage controller performing virtual storage space management.

Most computer systems include a relatively high capacity storage device for long-term data storage. In many systems, this storage device takes the form of a hard disk drive (HDD), although many systems have recently adopted a solid state drive (SSD) as an alternative due to attractive properties such as relatively high durability and storage capacity, as well as relatively low cost.

To store a file in a storage device, a computing system typically stores contents of the file, along with other information such as file attributes, a position of a block in which the file is stored, and so on. To store this data, the storage device must allocate a corresponding region of memory. This allocation process may be optimized to improve system performance by taking into consideration certain properties of the storage device as well as properties of the data.

### SUMMARY OF THE INVENTION

In one embodiment of the inventive concept, a storage device comprises a storage unit having a first size, and a storage controller configured to control data transfer between the storage unit and a host in response to a request from the host, and further configured to convey size information of the storage unit to the host such that the host perceives the storage unit to have a second size different from the first size.

In another embodiment of the inventive concept, a computing system comprises a storage unit having an actual space for storing data, a storage controller configured to generate a virtual space larger than the actual space of the storage unit, and a host configured to receive size information indicating a size of the virtual space, and to transmit requests to access the storage unit according to the size of the virtual space.

In another embodiment of the inventive concept, a method of operating a system comprising a storage unit comprises determining a first size corresponding to an actual amount of physical storage space in the storage unit, generating a virtual storage space having a second size greater than the first size, and conveying size information of the storage unit to the host such that the host perceives the storage unit to have the second size.

These and other embodiments of the inventive concept may potentially improve the performance of memory access by facilitating efficient memory addressing.

### BRIEF DESCRIPTION OF THE DRAWINGS

The drawings illustrate selected embodiments of the inventive concept. In the drawings, like reference numbers indicate like features.

FIG. 1 is a block diagram of a computing system according to an embodiment of the inventive concept.

FIG. 2 is a flowchart illustrating a method of operating a storage controller in the computing system of FIG. 1.

FIG. 3 is a conceptual diagram illustrating the operation of the storage controller in the computing system of FIG. 1.

FIG. 4 is a block diagram of a computing system according to another embodiment of the inventive concept.

FIG. 5 is a block diagram of a computing system according to still another embodiment of the inventive concept.

FIG. 6 is a block diagram of a computing system according to still another embodiment of the inventive concept.

FIG. 7 is a block diagram of a computing system according to still another embodiment of the inventive concept.

FIG. 8 is a block diagram of a computing system according to still another embodiment of the inventive concept.

### DETAILED DESCRIPTION

Embodiments of the inventive concept are described below with reference to the accompanying drawings. These embodiments are provided as teaching examples and should not be construed to limit the scope of the inventive concept.

In the description that follows, terms such as “a” and “an”, “the” and similar referents are to be construed to cover both the singular and the plural, unless otherwise indicated herein or clearly contradicted by context. Terms such as “comprising,” “having,” “including,” and “containing” are to be construed as open-ended terms unless otherwise noted.

Terms such as first, second, etc. may be used herein to describe various features, but these features should not be limited by these terms. Rather, these terms are used merely to distinguish one feature from another. Thus, for example, a first feature could alternatively be termed a second feature without departing from the presented teachings.

Unless defined otherwise, all technical and scientific terms used herein have the same meaning as commonly understood by one of ordinary skill in the art. The use of any and all examples, or example terms herein is intended merely to better illuminate the inventive concept and is not a limitation on the scope of the inventive concept unless otherwise specified. Further, unless defined otherwise, all terms defined in generally used dictionaries may not be overly interpreted.

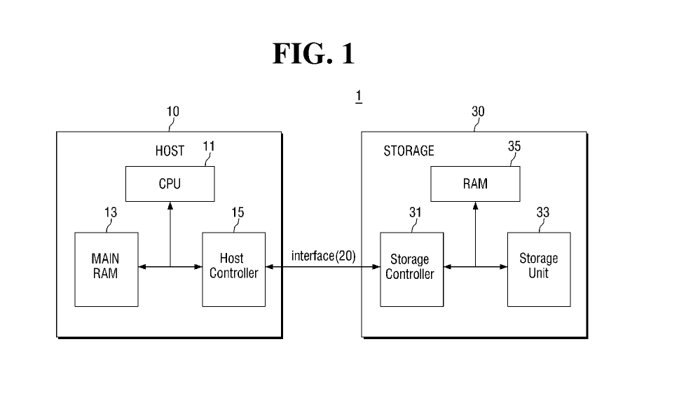

FIG. 1 is a block diagram of a computing system 1 according to an embodiment of the inventive concept.

Referring to FIG. 1, computing system 1 comprises a host 10, an interface 20 and a storage device 30. Host 10 comprises a processor 11, a main random access memory (RAM) 13 and a host controller 15. Host 10 sends requests to input and/or output data with respect to storage device 30.

Operations of computing system 1 will be explained with reference to data comprising both file data F_{DAT} and information for the file data(“file information data”) F_{INF}. File data F_{DAT} is data that is stored in storage device 30, and file information data F_{INF} is data that is not stored in storage device 30 but is used by storage device 30 to store file data F_{DAT}. File information data F_{INF} is data including information regarding file data F_{DAT} and may include, for example, information as to how often file data F_{DAT} is used by host 10, whether or not file data F_{DAT} is meta data, how to align multiple units of file data F_{DAT} when they are stored in storage unit 33, and where to store file data F_{DAT} in storage unit 33. Storage device 30 may use file information data F_{INF} when file data F_{DAT} is stored in storage unit 33. The use of file information data F_{INF} allows file information data F_{INF} to be stored in storage device 30, thereby improving performance of storage device 30.

Processor 11 may execute various computing functions and may comprise, for instance, a microprocessor or a central processing unit (CPU). Processor 11 is connected to main RAM 13, which may comprise, for instance, a dynamic random access memory (DRAM). Alternatively, main RAM 13 may be a static random access memory (SRAM), a flash memory, a phase change random access memory (PRAM), a ferroelectric random access memory (FRAM), a resistive random access memory (RRAM), or a magnetic random access memory (MRAM). Main RAM 13 fetches a module executed when processor 11 executes computing functions, and it may temporarily store data before transmitting the data to storage device 200.

Host controller 15 is connected to processor 11 and main RAM 13, and it transmits the data to storage device 30. Interface 20 connects host controller 15 of host 10 with storage controller 31 of storage device 30, and it executes data input/output between host 10 and storage device 30. Interface 20 may operate according to a standard such as, e.g., Advanced Technology Attachment (ATA), Integrated Drive Electronics (IDE), Serial Advanced Technology Attachment (SATA), or Non Volatile Memory Express (NVMe).

Storage device 30 inputs/outputs data from/to host 10 through interface 20. Storage device 30 comprises a storage controller 31, a storage unit 33, and a random access memory (RAM) 35.

RAM 35 stores an address translation table for converting logical addresses received from host 10 into physical addresses for storage unit 33. In some embodiments, RAM 35 operates as a write buffer that temporarily stores data provided from host 10 and/or a read cache that temporarily stores data output from storage unit 33. For example, RAM 35 may be a DRAM. Alternatively, RAM 35 may be an SRAM. While RAM 35 positioned outside storage controller 31 is illustrated in FIG. 1, it may also be positioned inside storage controller 31 according to some embodiments.

Storage unit 33 stores the data provided from host 10. Storage unit 33 may comprise, for example, NAND-FLASH, NOR-FLASH, PRAM, FRAM, RRAM, MRAM, a hard disk, a solid state drive (SSD), and so on. Storage unit 33 may include any of various types of volatile or non-volatile memory. Storage unit 33 has a defined amount of physical space for storing data, which will be referred to as a first size. Storage device 30 cannot store data larger than the first size.

Storage controller 31 is connected to host 10 through interface 20 and is connected to storage unit 33 and RAM 35. Storage controller 31 receives a command from host 10 and controls the operation of storage device 30 in response to the command. For example, storage controller 31 may control data transmission/reception between host 10 and storage device 30 through interface 20 and may relay data transmission/reception between storage unit 33 and host 10. Under these circumstances, storage controller 31 controls storage unit 33 in response to a request from host 10 for data input/output.

Storage controller 31 notifies host 10 of the size of storage unit 33. Host 10 requests data input/output according to the size of storage unit 33 notified by storage controller 31. Here, storage controller 31 may notify host 10 of the size of a virtual space (a second size) rather than the actual amount of physical space of storage unit 33 (the first size). In other words, storage controller 31 may notify host 10 that the size of storage unit 33 is a second size rather than the first size. Accordingly, host 10 may execute requests for data input/output to storage device 30 according to the second size. Here, the second size is larger than the first size and may be adjustable. Host 10 perceives the size of storage unit 10 as the second size through storage controller 31 and requests for data input/output to storage device 30 according to the second size.

Examples of storage device 30 shown in FIG. 1 may include smart media, a memory stick, a CF card, an XD card, a multimedia card, a hard disk, an external hard disk, a solid state disk (SSD), an external SSD, and so on. Nevertheless, storage device 30 is not limited to these examples.

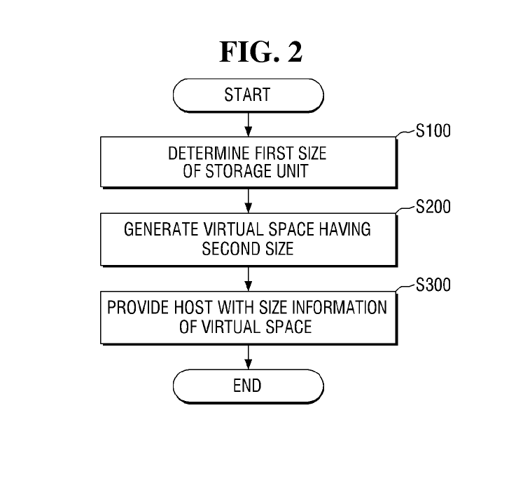

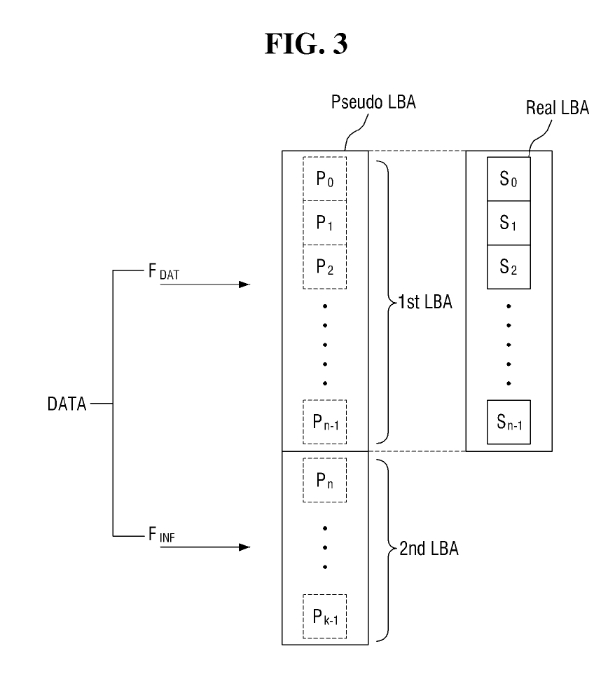

FIGS. 2 and 3 illustrate a method of operating storage controller 31 shown in FIG. 1, according to an embodiment of the inventive concept. In particular, FIG. 2 is a flowchart illustrating the method and FIG. 3 illustrates an example of the operation of storage controller 31 according to the method.

Referring to FIG. 2, storage controller 31 determines a size of storage unit 33 (S100). In other words, it determines a size of the actual space in which storage unit 33 can store data, i.e., the first size. This determination can be accomplished, for instance, by accessing stored information indicating the size.

Next, storage controller 31 generates a virtual space of storage unit 33 (S200). The virtual space may be larger than the actual space of storage unit 33, for example, the second size.

To generate the virtual space, storage controller 31 may use a logical block address (LBA). In detail, storage unit 33 may be divided into multiple sectors each having a physical address, and it may be accessed by sector to input/output data. As shown in FIG. 3, storage controller 31 may have “n” real LBAs S0, S1, S2, . . . , and Sn−1 corresponding to multiple physical addresses (n is a positive integer). Storage controller 31 may store the data received from host 10 in storage unit 33 using the n real LBAs. The n real LBAs may be mapped to physical addresses of storage unit 33 and may correspond to the first size of storage unit 33.

Storage controller 31 additionally generates k pseudo LBAs P0, P1, P2, . . . , and Pk−1 (k>n.). The k pseudo LBAs correspond to the second size of the virtual space generated by storage controller 31. Storage controller 31 provides host 10 with the k pseudo LBAs to control host 10 to transmit data using the k pseudo LBAs.

The k pseudo LBAs include first LBAs and second LBAs. Each of the first LBAs corresponds to one of the n real LBAs, and the number of first LBAs among the k pseudo LBAs is n. However, the second LBAs do not correspond to any of the n real LBAs, and the number of second LBAs among the k pseudo LBAs is (k−n). In other words, the k pseudo LBAs include n first LBAs corresponding to the real LBAs and k-n second LBAs not corresponding to the real LBAs.

In FIG. 3, pseudo-LBAs P0 through Pn−1 are illustrated as first LBAs among the k pseudo LBAs, matched with real LBAs S0 through Sn−1, and pseudo-LBAs Pn through Pk−1 are illustrated as second LBAs among the k pseudo LBAs. In general, the mapping between the pseudo-LBAs and the real LBAs could be other than that illustrated in FIG. 3.

Next, referring again to FIG. 2, storage controller 31 provides host 10 with the size information of the virtual space, that is, the second size (S300). Therefore, host 10 perceives that storage device 30 has the second size, and transmits the data to storage device 30 using the k pseudo LBAs corresponding to the second size.

Referring again to FIG. 3, where host 10 transmits the data, the first LBAs among the k pseudo LBAs, and the file information data F_{INF} which may be referred by the second LBAs may be used to transmit file data F_{DAT}. The combination of file data F_{DAT} and file information data F_{INF} may be used to efficiently store data in storage unit 33. Here, if file data F_{DAT} and file information data F_{INF} are concurrently provided to storage device 30 using the first LBAs, storage device 30 can rapidly and efficiently store file data F_{DAT}.

In some embodiments, the first LBAs and the second LBAs may be used in the following manner. Host 10 combines a selected one of the first LBAs with the file information data F_{INF} referred by a selected one of the second LBAs to produce a new LBA (a third LBA), and it transmits the third LBA to storage device 30. Accordingly, storage controller 31 may concurrently receive the selected first LBA and the file information data F_{INF} referred by the selected second LBA.

Next, storage controller 31 separates the received third LBA into the selected first LBA and the file information data F_{INF} referred by the selected second LBA. Using the above technique, host 10 may transmit multiple LBAs at a time using the k pseudo LBAs and storage device 30 may receive a larger amount of data.

Where storage controller 31 uses n real LBAs without generating a virtual space, host 10, interface 20 and storage device 30 cannot use LBAs other than the n real LBAs. Accordingly, if data is transmitted using LBAs other than the n real LBAs, it is perceived that the LBAs are erroneously used by host controller 15, interface 20, and storage controller 31, resulting in errors. This may prevent file data F_{DAT} and file information data F_{INF} from being provided concurrently, as in computing system 1. In addition, because file information data F_{INF} is not stored in storage unit 33, it is not efficient to use the first LBAs or the n real LBAs in providing storage unit 33 with file information data F_{INF}.

In computing system 1, to improve performance of storage device 30, storage controller 31 generates a virtual space having the second size larger than the actual space having the first size, and host 10 uses the k pseudo LBAs, which are more than the n real LBAs. For example, host 10 may transmit data to storage device 30 using the first LBAs for file data F_{DAT} and the file information data F_{INF} referred by the second LBAs.

Host 10 may transmit data to storage device 30 using the k pseudo LBAs and storage controller 31 may analyze the data received from host 10. Storage controller 31 may analyze whether the data is file data F_{DAT} or file information data F_{INF} and may classify the LBAs corresponding to file data F_{DAT} as first LBAs and LBAs corresponding to file information data F_{INF} as second LBAs. After the analyzing is completed, storage controller 31 may map the first LBAs to a physical address using file information data F_{INF} assigned as the second LBAs and may store file data F_{DAT} in storage unit 33.

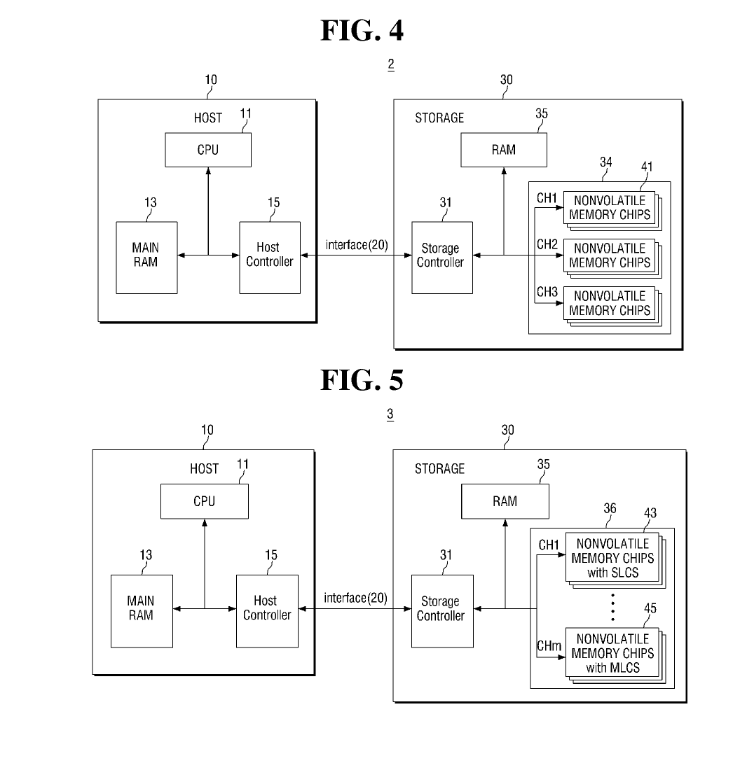

FIG. 4 is a block diagram of a computing system 2 according to another embodiment of the inventive concept.

Referring to FIG. 4, computing system 2 is similar to computing system 1 of FIG. 1, except that storage unit 33 is replaced by a storage unit 34 comprising multiple nonvolatile memory chips 41. Nonvolatile memory chips 41 are divided into multiple groups. The respective groups of nonvolatile memory chips 41 may be connected to storage controller 31 through a common channel. For example, nonvolatile memory chips 41 may be connected to storage controller 31 through first to mth channels CH1 to CHm. That is to say, storage unit 34 may include nonvolatile memory chips 41, which may be aligned to be connected to storage controller 31. In this case, file information data F_{INF} may include information on which one of nonvolatile memory chips 41 stores file data F_{DAT}. Accordingly, storage controller 31 may store file data F_{DAT} in a selected one among nonvolatile memory chips 41.

Nonvolatile memory chips 41 connected to one channel are illustrated in FIG. 4. However, storage unit 33 may be modified such that one among nonvolatile memory chips 41 is connected to one channel.

FIG. 5 is a block diagram of a computing system 3 according to still another embodiment of the inventive concept.

Referring to FIG. 5, computing system 3 is similar to computing system 2, except that storage unit 34 is replaced by a storage unit 36. Storage unit 36 comprises multiple nonvolatile memory chips 43 each comprising single level cells (SLCs) and multiple nonvolatile memory chips 45 each comprising multi level cells (MLCs). Here, file information data F_{INF} comprises information on whether file data F_{DAT} is to be stored in nonvolatile memory chips 43 comprising SLCs or in nonvolatile memory chips 45 comprising MLCs. File data F_{DAT} may be stored in nonvolatile memory chips 43 comprising SLCs or in nonvolatile memory chips 45 comprising MLCs according to file information data F_{INF}.

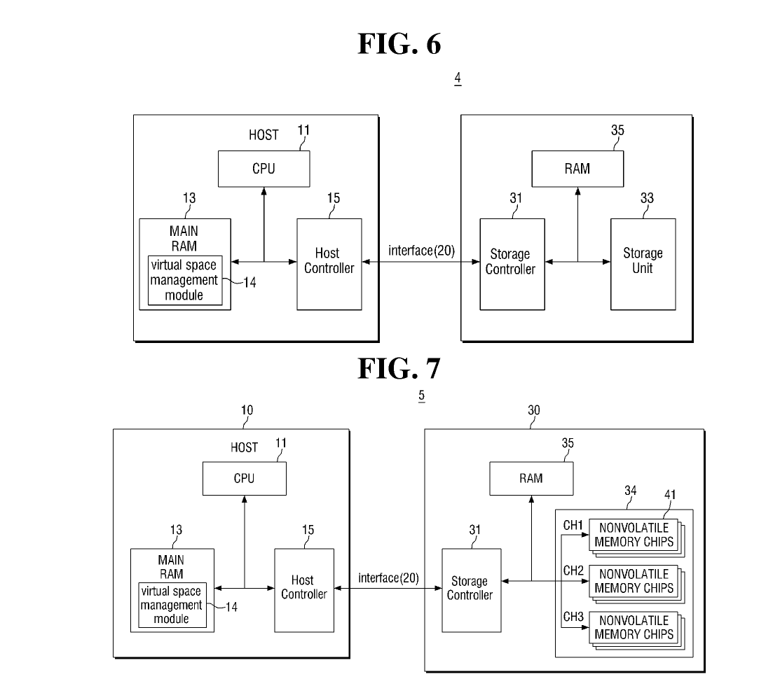

FIG. 6 is a block diagram of a computing system 4 according to still another embodiment of the inventive concept.

Referring to FIG. 6, computing system 4 is similar to computing system 1, except that main RAM 13 comprises a virtual space management module 14. Virtual space management module 14 controls storage controller 31 to manage a virtual space. Virtual space management module 14 controls storage controller 31 to generate the virtual space, and it provides host 10 with a size of the virtual space, that is, a second size. Virtual space management module 14 generates k pseudo LBAs P0, P1, P2, . . . , and Pk−1 (k>n.), which correspond to the second size of the virtual space. It then provides host 10 with the k pseudo LBAs to control host 10 to transmit data using the k pseudo LBAs. Host 10 perceives a size of storage unit 33 as the second size.

The k pseudo LBAs include first LBAs and second LBAs. The first LBAs include LBAs assigned to file data F_{DAT} and the second LBAs include LBAs assigned to file information data F_{INF}.

Storage controller 31 comprises n real LBAs corresponding to multiple physical addresses. Storage controller 31 stores the data received from host 10 in storage unit 33 using the n real LBAs. The n real LBAs may be mapped to physical addresses of storage unit 33 and may correspond to the first size of storage unit 33.

Each of the first LBAs may correspond to one of the n real LBAsand, the number of the first LBA among the k pseudo LBAs is n. However, the second LBA do not correspond to any of the n real LBAs, and the number of the second LBA is (k−n).

Host 10 transmits data to storage device 30 using the k pseudo LBAs corresponding to the second size provided from virtual space management module 14. In response to a request from host 10, virtual space management module 14 provides host 10 with the size of the actual space of storage unit 33, that is, the first size. Where host 10 intends to transmit data exceeding the first size to storage device 30, virtual space management module 14 may prevent host 10 from transmitting data exceeding the first size to storage device 30. In other words, virtual space management module 14 may restrict host 10 from providing storage unit 33 with the data exceeding the first size. In addition, a user of computing system 4 may adjust the size of the virtual space by means of virtual space management module 14. For example, the user may adjust the size of the virtual space by changing the size of k.

Meanwhile, virtual space management module 14 may receive data from host 10 to assign LBAs to the received data. Here, the first LBA may be assigned to file data F_{DAT} and file information data F_{INF} may referred by the second. Storage controller 31 may receive assigned LBAs through interface 20, and may store file data F_{DAT} in storage unit 33 by mapping the first LBA with a physical address using file information data F_{INF}.

Alternatively, virtual space management module 14 may receive data assigned to k pseudo LBAs from host 10. Here, virtual space management module 14 may analyze the data received from host 10 as file data F_{DAT} and file information data F_{INF} and may classify data LBA assigned to file data F_{DAT} as the first LBA and the LBA assigned to file information data F_{INF} as the second LBA. Storage controller 31 may receive the data analyzed as the first LBA and the second LBA and may store the received data in storage unit 33.

In the example of FIG. 6, virtual space management module 14 is executed in main RAM 13, but aspects of the inventive concept are not limited thereto. Virtual space management module 14 may be installed in a constituent element other than main RAM 13, for example, a read only memory (ROM) (not shown).

FIG. 7 is a block diagram of a computing system 5 according to still another embodiment of the inventive concept.

Referring to FIG. 7, computing system 5 is similar to computing system 4, except that storage unit 33 is replaced by storage unit 34, which comprises multiple nonvolatile memory chips 41 divided into multiple groups. The respective groups of nonvolatile memory chips 41 may be connected to storage controller 31 through a common channel. For example, nonvolatile memory chips 41 may be connected to storage controller 31 through first to mth channels CH1 to CHm. That is to say, storage unit 34 may include nonvolatile memory chips 41, which may be aligned to be connected to storage controller 31. In this case, file information data F_{INF} may include information on which one of nonvolatile memory chips 41 stores file data F_{DAT}. Accordingly, storage controller 31 may store file data F_{DAT} in a selected one among nonvolatile memory chips 41.

While nonvolatile memory chips 41 connected to one channel are illustrated in FIG. 7, storage unit 33 may be modified such that one among nonvolatile memory chips 41 is connected to one channel.

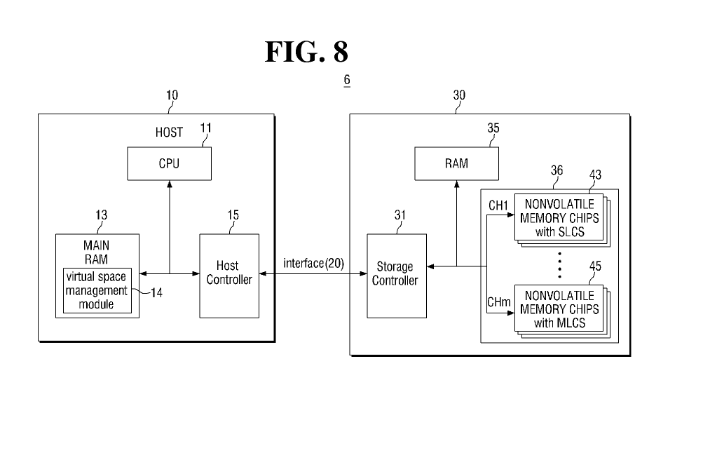

FIG. 8 is a block diagram of a computing system 6 according to still another embodiment of the inventive concept.

Referring to FIG. 8, computing system 6 is similar to computing system 4 except that storage unit 33 is replaced by storage unit 36. Storage unit 36 comprises multiple nonvolatile memory chips 43 each comprising SLCs and multiple nonvolatile memory chips 45 each comprising MLCs. Here, file information data F_{INF} may include information on whether file data F_{DAT} is to be stored in nonvolatile memory chips 43 or in nonvolatile memory chips 45. File data F_{DAT} may be stored in nonvolatile memory chips 43 comprising of SLCs or in nonvolatile memory chips 45 comprising MLCs according to file information data F_{INF}.

The foregoing is illustrative of embodiments and is not to be construed as limiting thereof. Although a few embodiments have been described, those skilled in the art will readily appreciate that many modifications are possible in the embodiments without materially departing from the scope of the inventive concept. Accordingly, all such modifications are intended to be included within the scope of the inventive concept as defined in the claims.

What is claimed is:

1. A storage device, comprising:
a storage unit having a first size; and
a storage controller configured to control data transfer between the storage unit and a host in response to a request from the host, and further configured to convey size information of the storage unit to the host such that the host perceives the storage unit to have a second size different from the first size.

2. The storage device of claim 1, wherein the second size is larger than the first size.

3. The storage device of claim 2, wherein the second size is adjustable.

4. The storage device of claim 1, wherein the storage controller is still further configured to convey size information of the storage unit indicating the first size in response to a request from the host.

5. The storage device of claim 1, wherein the storage controller accesses the storage unit using n real logical block addresses (LBAs) corresponding to the first size, and
wherein the storage controller receives data from the host using at least one of k pseudo LBAs corresponding to the second size (k>n).

6. The storage device of claim 5, wherein the k LBAs include first LBAs and second LBAs, each of the first LBAs corresponding to one of the n LBAs, and the second LBAs not corresponding to any the n LB As.

7. The storage device of claim 6, wherein the data includes file data stored in the storage unit and file information data regarding the file data, wherein the first LBAs are used to transmit the file data and the second LBAs are used to transmit the file information data.

8. The storage device of claim 7, wherein the storage controller receives the first LBAs and the file information data concurrently.

9. A computing system, comprising:
a storage unit having an actual space for storing data;
a storage controller configured to generate a virtual space larger than the actual space of the storage unit; and
a host configured to receive size information indicating a size of the virtual space, and to transmit requests to access the storage unit according to the size of the virtual space.

10. The computing system of claim 9, wherein the host further comprises a virtual space management module configured to manage the virtual space.

11. The computing system of claim 9, wherein the actual space has a first size, the virtual space has a second size, and the host perceives that the storage unit has the second size.

12. The computing system of claim 11, wherein the virtual space management module is configured to convey size information of the storage unit indicating the first size in response to a request from the host.

13. The computing system of claim 12, wherein the virtual space management module is further configured to restrict the host from providing data of the first size or greater to the storage unit.

14. The computing system of claim 10, wherein the virtual space management module is further configured to adjust a size of the virtual space.

15. The computing system of claim 10, wherein the virtual space corresponds to k LBAs and the actual space corresponds to n LBAs corresponding to the k LBAs (n<k).

16. The computing system of claim 15, wherein the data comprises file data and file information data regarding the file data, and (k−n) LBAs not corresponding to the n LBAs among the k LBAs are used as LBAs for the file information data.

17. A method of operating a system comprising a storage unit, comprising:
determining a first size corresponding to an actual amount of physical storage space in the storage unit;
generating a virtual storage space having a second size greater than the first size; and
conveying size information of the storage unit to the host such that the host perceives the storage unit to have the second size.

18. The method of claim 17, further comprising:
receiving, by the storage controller, a request to access the storage unit, wherein the request comprises a first logical block address (LBA) corresponding to a physical block address of the physical storage space, and file information data referred by the second LBA not corresponding to any physical block address of the physical storage space.

19. The method of claim 18, wherein the first LBA corresponds to file data and the file information data is regarding to the file data.

20. The method of claim 19, further comprising identifying the file data and the file information data using the first LBA.
